(19) United States
(12) Patent Application Publication
(10) Pub. No.: US 2026/0297251 A1
(43) Pub. Date: Oct. 1, 2026

(54) PROCESS FOR MANUFACTURING POLYALKYLENE GLYCOLS

(71) Applicant: BASF SE, Ludwigshafen am Rhein (DE)

(72) Inventors: Sophie MAITRO-VOGEL, Ludwigshafen (DE); Frank DIETSCHE, Ludwigshafen (DE); Simon REIFEGERSTE, Ludwigshafen (DE); Alexandra WIEDEMANN, Ludwigshafen (DE); Simon BURK, Ludwigshafen (DE)

(21) Appl. No.: 19/483,357

(22) PCT Filed: May 15, 2024
(86) PCT No.: PCT/EP2024/063386

§ 371 Date: Nov. 11, 2025

(30) Foreign Application Priority Data
May 24, 2023 (EP) 23175041.5

(51) Int. Cl. C08G 65/26

(52) U.S. Cl. CPC C08G 65/2648

(57) ABSTRACT

Disclosed herein is a process for manufacturing polyalkylene glycols with a molecular weight Mw of at least 4000 g/mol determined by gel permeation chromatography.

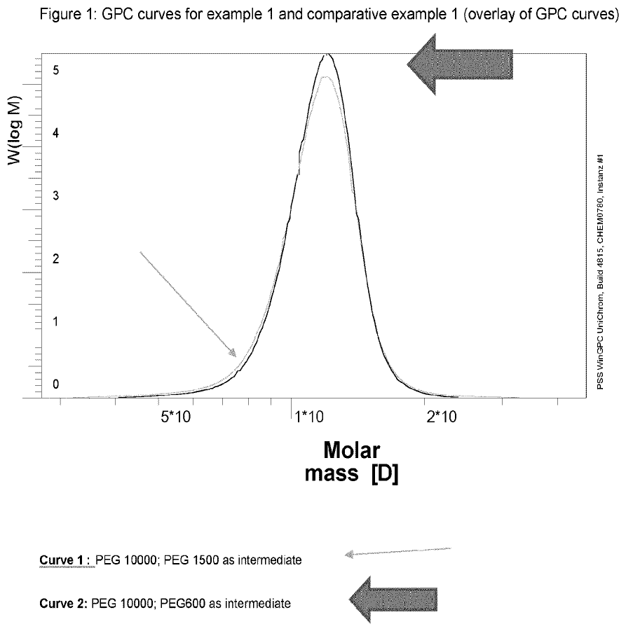

The present invention relates to a process for manufacturing polyalkylene glycols with a molecular weight Mw of at least 4000 g/mol, the respective polyalkylene glycols and uses of the polyalkylene glycols.

Polyalkylene glycols (PAG), e.g. polyethylene glycols (PEG) or polypropylene glycol, are a well-known class of compounds with many industrial uses.

U.S. Pat. No. 8,987,529 B2 describes a process for manufacturing polyether polyols, using mainly sugars as starting compounds. For example, sorbitol is disclosed as a starter compound in the experimental examples, which has two primary and four secondary OH functionalities, i. e. six in total. The polydispersity of the resulting polyether polyols is broad.

US 2009/005533 A1 discloses a process for producing polyether alcohols, based on a starter mixture of sucrose and diethylene glycol. The Pd of the resulting product is broad.

US 2009/048420 A1 describes a process for preparation of polyols, which starts from a polymeric alkoxylate.

However, the manufacturing of polyalkylene glycols with a high molecular weight may pose problems. For example, the polydispersity of the resulting polyalkylene glycols may be unsatisfactory. In general, a low polydispersity is desirable.

Furthermore, the generation of 1,4-dioxane as a side product in ethoxylation reactions poses problems, since 1,4-dioxane is under suspicion of causing problems to the human health (may cause cancer). Besides, the content of salts in the polyalkylene glycols may be problematic in some applications, for example in uses for polyurethane thickeners.

Thus, it was one object of the present invention to provide a manufacturing process which leads to high molecular weight polyalkylene glycols, in particular high molecular weight polyalkylene glycols with a low polydispersity. A polydispersity of the high molecular polyalkylene glycols of less than 1.05 would be preferred.

Furthermore, it was an object of the present invention to provide a manufacturing process for high molecular weight polyalkylene glycols with a low total batch time.

It was another object of the present invention to provide a manufacturing process which leads to high molecular weight polyalkylene glycols with a low (or decreased) level of 1,4-dioxane, thus leading to more sustainable products. Furthermore, it was an object to provide a manufacturing process which leads to high molecular weight polyalkylene glycols with a low content of salts, preferably less than 200 ppm of sodium and potassium salts (total sum of both salts).

Preferably, the amount of potassium in the polyalkylene product should be less than 20 ppm or even less than 15 ppm.

The inventors have surprisingly found that a two-step process which involves a low molecular polyalkylene glycol intermediate solves the problems mentioned above.

Therefore, one subject of the present invention is a process for manufacturing polyalkylene glycols (PGProd) with a molecular weight Mw of at least 4000 g/mol, comprising the steps of
(i) providing a starter compound (S) with at least two OH-functionalities, wherein starter compound (S) has a molecular weight of at most 200 g/mol, and an alkaline catalyst, and
(ii) alkoxylating starter compound (S) under alkaline catalysis to obtain a polyalkylene glycol (PG1) with a molecular weight Mw in the range of 400 to 1100 g/mol, and, preferably, a polydispersity of less than 1.1, and
(iii) further alkoxylating polyalkylene glycol (PG1) under alkaline catalysis to obtain polyalkylene glycols (PGProd) with a molecular weight of at least 4000 g/mol and, preferably, a polydispersity of less than 1.05, and, optionally,
(iv) neutralizing the reaction mixture containing polyalkylene glycols (PGProd).

The molecular weight and polydispersity of the polyalkylene glycols, respectively polyethylene glycols, may be measured by gel permeation chromatography (GPC), e. g. under the following conditions:

The polydispersity (D-value) is defined by the ratio of the weight-average molar mass Mw and the number-average molar mass Mn.

The level of 1,4-dioxane in the final polyalkylene glycol (PGProd) may be determined by GC-MS (gas chromatography-mass spectrometry) or HPLC (high pressure liquid chromatography). For example, the content of dioxane in alkoxylates, like the inventive polyalkylene glycols (PGProd), may be done by headspace gas chromatography, detected with a flame ionization detector (FID); quantification may be done based on a standard addition method. The standard solution may be prepared by weighing 1,4-dioxane into a volumetric flask and diluting with water to obtain several different concentrations, e. g. 5.0 and less than 1.0 ppm dioxane (wt.-ppm, relative to mass of final product).

The content of salts may in the inventive polyalkylene glycols may be determined by atomar absorption spectroscopy (AAS).

In an embodiment of the inventive process, polyalkylene glycol (PG1) is isolated and transferred into another reaction vessel for further alkoxylating step (iii).

In a preferred embodiment of the inventive process, the intermediate polyalkylene glycol (PG1) has a molecular weight in the range of 500 to 1100 g/mol, preferably 500 to 1000 or 500 to 800 g/mol, for example 600 g/mol (equivalent to an OH number range between 178 to 197 mg KOH/g, according to German industry standard DIN no. 53240). In a further preferred embodiment, the final polyalkylene glycol (PGProd) has a molecular weight of at least 6000 g/mol, preferably at least 8000 g/mol, and, preferably, at most 15000 g/mol, more preferably at most 13000 g/mol.

The molecular weight values in this invention refer, unless otherwise noted, to the average molecular weight (Mw), as determined by GPC (see above).

Preferably, water is removed after step (i) before alkoxylation of step (ii) starts. This can be done by vacuum stripping, usually at a pressure of less than 250 mbar, preferably less than 150 mbar, e. g. at around 100 mbar (in some cases, around 50 mbar) and/or at a temperature of more than 100° C., preferably 120° C. or more, e. g. between 120° C. and 140° C.

These conditions may be applied for a period of at least one minute, or for a period of at least five minutes, usually at least ten minutes (and/or, preferably, not more than 60 minutes).

In one embodiment of the inventive process, the alkaline catalyst used in steps (ii) and (iii) may be selected, separately from each other, from the list consisting of sodium hydroxide, potassium hydroxide, sodium methanolate and potassium methanolate, elemental sodium, alloys of sodium and potassium, and mixtures thereof.

The concentration of alkaline catatyst in step (ii) is, in a preferred embodiment of the inventive process, lower than the concentration of alkaline catalyst in step (iii).

The concentration of alkaline catatyst in step (ii) is preferably at most 7% by weight, relative to the weight of the starter (S).

Preferably, the concentration of alkaline catatyst in step (iii) is at most 1.33% by weight, relative to the intermediate polyalkylene glycol (PG1).

In an embodiment of the inventive process, the concentration of alkaline catalyst in step (ii) is in the range of 0.05 to 3.00 mol % per OH group of the starter (S), preferably 0.25 to 3.00 mol %, and/or the concentration of alkaline catalyst in step (iii) is in the range of 0.05 to 25.00 mol % per OH group of the starter (S), preferably 1.00 to 18.00 mol %.

Generally, when ethylene oxide (EO) is used for alkoxylation, the concentration of alkaline catalyst may be lower than when propylene oxide (PO) is used.

Regarding the alkylene oxide, ethylene oxide (EO) and/or propylene oxide (PO) are preferably used for alkoxylation in steps (ii) and (iii) of the inventive process, separately from each other, preferably ethylene oxide (EO).

The starter compound (S) for the inventive process may be selected from compounds with two or three OH-functionalities. The starter compound (S) may be dissolved in a solvent, preferably selected from water and/or methanol.

In an embodiment of the inventive process, the starter compound (S) may be selected from triethanolamine and/or tripropylalcohol amine.

In the inventive process, the starter compound (S) may also be selected from the list consisting of ethylene glycol, diethylene glycol, monopropylene glycol, dipropylene glycol, castor oil, fatty alcohols with 12 to 14 C atoms, Tridecanol N, 2-propylheptanol, methyldiglycol, trimethylolpropane, methyltriglycol, and mixtures thereof, preferably from dipropylene glycol and diethylene glycol, more preferably diethylene glycol.

Said fatty alcohols with 12 to 14 C atoms may be used in various combinations and different ratios of constituents. Fatty alcohols with 12 to 14 C atoms may, in one embodiment, be selected from the list consisting of 1-dodecanol (laury alcohol), 1-tetradecanol (myristyl alcohol), 1-hexadecanol (cetyl alcohol) and mixtures thereof.

For example, in one embodiment, starter compound (S) may be selected from fatty alcohols with 12 to 14 C atoms, wherein fatty alcohols with 12 to 14 C atoms consist of 1-dodecanol (laury alcohol) and 1-tetradecanol (myristyl alcohol), in a molar ratio of 1:3 to 3:1.

In the inventive process, the temperature in step (ii) may be in the range of 120° to 200° C., preferably 140° to 175° C., and/or the temperature in step (iii) may be in the range of 120° C. to 180°, preferably 130° to 160° C.

In an embodiment of the inventive process, neutralizing the reaction mixture containing polyalkylene glycols (PGProd) is done with a compound selected from the list consisting of phosphoric acid, lactic acid, acetic acid, isononanic acid and mixtures thereof.

In the inventive process, the product may be precipitated after step (iii) or (iv), preferably by adding a compound selected from ion exchanger and/or phosphoric acid. For example, Magnesol® may be used for this purpose.

The resulting high molecular weight polyalkylene glycol may be (at room temperature, i. e. 20° C.) in the form of a liquid, a paste, a solid, a powder, cast solids or in the form of flakes.

### Applications

The polyalkylene glycols obtained or obtainable by the inventive process may, inter alia, be used for manufacturing of polyurethane thickeners or as a formulation additive in detergent compositions, or as a carrier for solid detergent compositions, or as binding agent for solid automatic dishwashing formulations (e. g. tablets), or as a (osmotic) laxative.

The polyalkylene glycols obtained or obtainable by the inventive process may furthermore, inter alia, be used as solubilizers, plasticizers, binders, humectants, lubricants, dispersing agents or mould-release agents. Besides, the polyalkylene glycols obtained or obtainable by the inventive process may be used to modify the consistency of liquids and to impregnate materials, and as organic intermediates in the manufacture of polyesters and polyurethanes.

### WORKING EXAMPLES

In the following paragraphs, some experimental examples may be found which serve to illustrate some aspects of the present invention.

In the examples and comparative examples described below, polyalkylene glycols were manufactured according to the following general procedure.

A starter compound (S) with at least two OH-functionalities and with a molecular weight of at most 200 g/mol was provided in the reaction vessel/autoclave. An alkaline catalyst (usually, unless otherwise noted, KOH as a 45 wt. % aqueous solution) was added. Water was removed by applying a vacuum of less than 150 mbar and a temperature of at least 90° C. for at least one minute.

The starter compound (S) was alkoxylated by adding alkylene oxide (ethylene oxide) at a temperature of minimum 170° C. over a period of several hours. A post-reaction time of min. 30 minutes to three hours followed, without further alkylene oxide dosing.

An intermediate polyalkylene glycol (PG1) was obtained and removed from the reaction vessel and analysed by GPC.

The intermediate polyalkylene glycol (PG1) was provided in reaction vessel. An addition of alkaline catalyst (usually, unless otherwise noted, KOH as a 45 wt. % aqueous solution) dosage was added. Water was removed by applying a vacuum of less than 150 mbar and a temperature of at least 90° C. for at least one minute.

The intermediate polyalkylene glycol (PG1) was alkoxylated by adding alkylene oxide (ethylene oxide) at a temperature of 135° C. over a period of ca. nine hours. A post-reaction time of two to three hours followed.

The resulting polyalkylene glycols (PGProd) was neutralized by addition of acetic acid (100% active content) and optionally with further additives (e.g. BHT).

The resulting polyalkylene glycols (PGProd) was removed from the vessel and analysed by GPC.

### Example 1: Manufacture of a Polyethylene Glycol with a Molecular Weight of 10000 g/mol, with Intermediate Product PEG with Mw of 600 g/mol

The experiments were conducted in a production scale according to the general procedure described above. The intermediate polyethylene glycol had a molecular weight Mw of 600 g/mol (as determined by GPC, as described above).

The resulting polyethylene glycol had a molecular weight Mw of 10000 g/mol (as determined by GPC, as described above) and a polydispersity of 1.040. The dioxane content was lower than 1 ppm. The content of potassium salts, as determined by atomar absorption spectroscopy (AAS), was 11 ppm, and the content of sodium salts, as determined by atomar absorption spectroscopy (AAS), was 130 ppm.

### Comparative Example 1: Manufacture of a Polyethylene Glycol with a Molecular Weight of 10000 g/mol, with Intermediate Product PEG with Mw of 1500 g/mol

The experiments were conducted according to the general procedure described above; however, the intermediate polyethylene glycol had a molecular weight Mw of 1500 g/mol (as determined by GPC, as described above).

The resulting polyethylene glycol had a molecular weight Mw of 10000 g/mol (as determined by GPC, as described above) and a polydispersity of 1.055.

TABLE 1
data for Example 1 and Comparative Example 1

| | PEG 10 000 (PEG 1500 as | PEG 10 000 (PEG 600 as |
|---|---|---|
| Product | intermediate) | intermediate) |
| Mn | 1.1140e4 g/mol | 1.1329e4 g/mol |
| Mw | 1.1750e4 g/mol | 1.1783e4 g/mol |
| D-value | 1.0548e0 | 1.0400e0 |

Further similar experiments were conducted by the inventors.

For example, high molecular weight polyethylene glycols with a molecular weight of ca. 13000 g/mol were manufactured either from an intermediate polyethylene glycol with a molecular weight of 600 g/mol (inventive) or from an intermediate polyethylene glycol with a molecular weight of 1500 g/mol (comparative).

The experiment and comparative experiment also showed the same trend, e. g. regarding the polydispersity (considerably lower in the inventive product than in the comparative product), dioxane level (relatively low in the inventive product) and content of sodium and potassium salts (relatively low in the inventive product).

The experimental examples show that the inventive process, which involves a relatively low molecular weight intermediate polyalkylene glycol (e. g. Mw 600 g/mol), leads to high molecular weight products with considerably lower polydispersity, as compared to a conventional process which runs through a medium molecular weight intermediate (e. g. Mw 1500 g/mol).

Embodiments of the present invention are further described by the following points.
1) Process for manufacturing polyalkylene glycols (PGProd) with a molecular weight Mw of at least 4000 g/mol, determined by gel permeation chromatography, comprising the steps of
   (i) providing a starter compound (S) with at least two OH-functionalities, wherein starter compound (S) has a molecular weight of at most 200 g/mol, and an alkaline catalyst, and
   (ii) alkoxylating starter compound (S) under alkaline catalysis to obtain a polyalkylene glycol (PG1) with a molecular weight Mw in the range of 400 to 1100 g/mol, and, preferably, a polydispersity of less than 1.1, and
   (iii) further alkoxylating polyalkylene glycol (PG1) under alkaline catalysis to obtain polyalkylene glycols (PGProd) with a molecular weight of at least 4000 g/mol and, preferably, a polydispersity of less than 1.05, and, optionally,
   (iv) neutralizing the reaction mixture containing polyalkylene glycols (PGProd).
2) Process according to point 1, wherein polyalkylene glycol (PG1) is isolated, neutralised and transferred into another reaction vessel for further alkoxylating in step (iii).
3) Process according to point 1 or 2, wherein polyalkylene glycol (PGProd) has a molecular weight of at least 6000 g/mol, preferably at least 8000 g/mol, and, preferably, at most 15000 g/mol, more preferably at most 13000 g/mol.
4) Process according to any one of the preceding points, wherein polyalkylene glycol (PG1) has a molecular weight in the range of 500 to 1100 g/mol, preferably 500 to 1000 or 500 to 800 g/mol.
5) Process according to any one of the preceding points, wherein water is removed after step (i) and/or after step (ii).
6) Process according to any one of the preceding points, wherein an alkaline catalyst selected from the list consisting of sodium hydroxide, potassium hydroxide, sodium methanolate and potassium methanolate, elemental sodium, alloys of sodium and potassium, and mixtures thereof is used in step (ii).
7) Process according to any one of the preceding points, wherein an alkaline catalyst selected from the list consisting of sodium hydroxide, potassium hydroxide, sodium methanolate and potassium methanolate, elemental sodium, alloys of sodium and potassium, and mixtures thereof is used in step (iii), preferably sodium hydroxide.
8) Process according to any one of the preceding points, wherein ethylene oxide (EO) and/or propylene oxide (PO) is used for alkoxylation in step (ii), preferably ethylene oxide (EO).
9) Process according to any one of the preceding points, wherein ethylene oxide (EO) and/or propylene oxide (PO) is used for alkoxylation in step (iii), preferably ethylene oxide (EO).
10) Process according to any one of the preceding points, wherein starter compound (S) is selected from compounds with two or three OH-functionalities and/or wherein the starter compound (S) is dissolved in a solvent, preferably selected from water and/or methanol.
11) Process according to any one of the preceding points, wherein starter compound (S) is selected from triethanolamine, tripropylalcohol amine and mixtures thereof.
12) Process according to any one of the preceding points, wherein starter compound (S) is selected from the list consisting of ethylene glycol, diethylene glycol, monopropylene glycol, dipropylene glycol, castor oil, fatty alcohols with 12 to 14 C atoms, Tridecanol N, 2-propylheptanol, methyldiglycol, trimethylolpropane, methyltriglycol, and mixtures thereof, preferably from dipropylene glycol and diethylene glycol, more preferably diethylene glycol.
13) Process according to any one of the preceding points, wherein the concentration of alkaline catatyst in step (ii) is lower than the concentration of alkaline catalyst in step (iii), and is preferably at most 7% by weight, relative to the weight of the starter (S).
14) Process according to any one of the preceding points, wherein the concentration of alkaline catatyst in step (iii) is at most 1.33% by weight, relative to the intermediate polyalkylene glycol (PG1).
15) Process according to any one of the preceding points, wherein the temperature in step (ii) is in the range of 120° to 200° C., preferably 140° to 175° C.
16) Process according to any one of the preceding points, wherein the temperature in step (iii) is in the range of 120° C. to 180°, preferably 130° to 160° C.
17 Process according to any one of the preceding points, wherein neutralizing the reaction mixture containing polyalkylene glycols (PGProd) is done with a compound selected from the list consisting of phosphoric acid, lactic acid, acetic acid, isononanic acid and mixtures thereof.
18) Process according to any one of the preceding points, wherein the product is precipitated after step (iii) or (iv), preferably by adding a compound selected from ion exchanger and/or phosphoric acid.
19) Polyalkylene glycol (PGProd) with a molecular weight Mw of at least 4000 g/mol, determined by gel permeation chromatography, obtainable or obtained by the process of any one of points 1 to 18, optionally additionally comprising at least one antioxidation agent, preferably butylated hydroxytoluene (BHT) and/or tocopherol.
20) Use of polyalkylene glycol (PGProd) with a molecular weight Mw of at least 4000 g/mol, determined by gel permeation chromatography, preferably obtainable or obtained by the process of any one of points 1 to 18, in manufacturing of polyurethane thickeners or as a formulation additive in detergent compositions, or as a carrier for solid detergent compositions

### FIGURES

The attached figures show GPC curves for the inventive example and comparative example.

1. A process for manufacturing polyalkylene glycols (PGProd) with a molecular weight Mw of at least 4000 g/mol, determined by gel permeation chromatography, comprising the steps of
(i) providing a starter compound (S) with at least two OH-functionalities, wherein starter compound (S) has a molecular weight of at most 200 g/mol, and an alkaline catalyst,
(ii) alkoxylating the starter compound (S) under alkaline catalysis to obtain a polyalkylene glycol (PG1) with a molecular weight Mw in the range of 400 to 1100 g/mol, and a polydispersity of less than 1.1,
(iii) further alkoxylating polyalkylene glycol (PG1) under alkaline catalysis to obtain polyalkylene glycols (PGProd) with a molecular weight of at least 4000 g/mol,
(iv) optionally, neutralizing a reaction mixture containing polyalkylene glycols (PGProd),
wherein the starter compound (S) is selected from compounds with two or three OH-functionalities.

2. The process according to claim 1, wherein polyalkylene glycol (PG1) is isolated, neutralised and transferred into another reaction vessel for further alkoxylating in step (iii).

3. The process according to claim 1, wherein
polyalkylene glycol (PGProd) has a molecular weight of at least 6000 g/mol.

4. The process according to claim 1, wherein polyalkylene glycol (PG1) has a molecular weight in the range of 500 to 1100 g/mol.

5. The process according to claim 1, wherein water is removed after step (i) and/or after step (ii).

6. The process according to claim 1, wherein the alkaline catalyst selected from the group consisting of sodium hydroxide, potassium hydroxide, sodium methanolate and potassium methanolate, elemental sodium, alloys of sodium and potassium, and mixtures thereof is used in step (ii).

7. The process according to claim 1, wherein the alkaline catalyst selected from the group consisting of sodium hydroxide, potassium hydroxide, sodium methanolate and potassium methanolate, elemental sodium, alloys of sodium and potassium, and mixtures thereof is used in step (iii).

8. The process according to claim 1, wherein ethylene oxide (EO) and/or propylene oxide (PO) is used for the alkoxylating in step (ii).

9. The process according to claim 1, wherein ethylene oxide (EO) and/or propylene oxide (PO) is used for the alkoxylating in step (iii).

10. The process according to claim 1, wherein the starter compound (S) is dissolved in a solvent.

11. The process according to claim 1, wherein the starter compound (S) is selected from the group consisting of triethanolamine, tripropylalcohol amine and mixtures thereof.

12. The process according to claim 1, wherein the starter compound (S) is selected from the group consisting of ethylene glycol, diethylene glycol, monopropylene glycol, dipropylene glycol, castor oil, fatty alcohols with 12 to 14 C atoms, Tridecanol N, 2-propylheptanol, methyldiglycol, trimethylolpropane, methyltriglycol, and mixtures thereof.

13. The process according to claim 1, wherein a concentration of the alkaline catatyst in step (ii) is lower than a concentration of the alkaline catalyst in step (iii), relative to the weight of the starter compound (S).

14. The process according to claim 1, wherein a concentration of alkaline catatyst in step (iii) is at most 1.33% by weight, relative to the intermediate polyalkylene glycol (PG1).

15. The process according to claim 1, wherein a temperature in step (ii) is in the range of 120° to 200° C.

16. The process according to claim 1, wherein a temperature in step (iii) is in the range of 120° C. to 180° C.

17. The process according to claim 1, wherein neutralizing the reaction mixture containing polyalkylene glycols (PGProd) is done with a compound selected from the group consisting of phosphoric acid, lactic acid, acetic acid, isononanic acid, and mixtures thereof.

18. The process according to claim 1, wherein the polyalkylene glycols (PGProd) is precipitated after step (iii) or (iv).

19. A polyalkylene glycol (PGProd) with a molecular weight Mw of at least 4000 g/mol, determined by gel permeation chromatography, obtainable or obtained by the process of claim 1, optionally additionally comprising at least one antioxidation agent.

20. A method of using the polyalkylene glycol (PGProd) with a molecular weight Mw of at least 4000 g/mol, determined by gel permeation chromatography, obtained by the process of claim 1, the method comprising using the polyalkylene glycol (PGProd) in manufacturing of polyurethane thickeners or as a formulation additive in detergent compositions, or as a carrier for solid detergent compositions.
